(19) United States
(12) Patent Application Publication
(10) Pub. No.: US 2012/0173349 A1
(43) Pub. Date: Jul. 5, 2012

(54) ELECTRONIC TRANSACTION SYSTEM

(76) Inventor: Richard William Buckley, Chippenham (GB)

(21) Appl. No.: 13/320,074

(22) PCT Filed: May 14, 2010
(86) PCT No.: PCT/GB2010/000973

§ 371 Date: Dec. 16, 2011

(30) Foreign Application Priority Data
May 14, 2009 (GB) 0908305.6

(51) Int. Cl. G06Q 40/00

(52) U.S. Cl. 705/16; 705/39; 705/44

(57) ABSTRACT

An electronic transaction system uses an electronic transaction device; and a plurality of balances, each being linked to the transaction device and electronically stored in association with a transaction scheme. Transaction processing means processes a transaction request to provide an outcome in which the balances associated with the transaction scheme may be modified.

The present invention relates generally to electronic transaction systems, and more specifically to transaction systems involving the use of electronic payment devices such as smart payment cards.

Electronic payment devices such as electronic cards of various types are well known and ubiquitous in modern life. Commonly used types of payment cards include credit cards, debit cards, charge cards, gift cards, electronic purses, pre-paid cards and stored value cards. Such cards typically involve the management of financial resources which the card holder either owns or is authorised to use. Although the present invention is ideally suited for use with stored value cards, it is also applicable to all types of electronic payment devices, and is not limited in this regard.

With regard to stored-value cards, the funds are stored, as a value, on the card itself. Transport system cards and pre-paid telephone cards are known examples of such technology. Such cards have a single balance which is physically stored on the card, possibly along with other pertinent data.

However, storing a single balance does not provide a great deal of flexibility for the card user or issuer. Any transactions or purchases made with the card are applied to the one and only balance. This means that, when a user wishes to make a purchase or other transaction the use of several or many cards may be required, each with its own balance, to manage and manipulate multiple funds. For example, a loyalty points card may be required to utilise a retailer's rewards scheme, and a financial payment card, such as a debit card or gift card, needed to pay for the transaction.

Thus, it would be beneficial to a user to be able to combine more than one fund or resource onto a single transaction device, such as a payment card, so as to reduce or eliminate the need to carry numerous cards or devices, which can be cumbersome and inconvenient.

In addition, much greater transaction flexibility may be achieved by replacing a single payment application balance with many that are grouped into schemes. This can significantly alter user behavior, for example a coffee may be paid for from a “hot drinks” sub-balance belonging to a coffee shop scheme while the muffin has to be paid for by the primary balance. In this manner, payment application issuers are granted much greater scope to entice users into more frequent transactions, resulting in potentially greater revenue. Users, by way of example, may now be rewarded for particular types of preferred activity.

Thus, it is desirable to provide a transaction system which enables the management of, and access to, multiple balances on a single transaction device. Additionally, intelligent management of the multiple funds or resources is desired so as to encourage (or discourage) certain types of user behaviour, thus increasing revenue for service providers, retailers and/or card providers.

Thus, in accordance with the present invention, there is provided an electronic transaction system, the system comprising:
an electronic payment device;
a plurality of balances, each being linked to the payment device and electronically stored in association with a payment scheme;
transaction processing means for processing a transaction request associated with the electronic payment device, the transaction processing means comprising means for inputting the transaction request and processing the transaction request to an outcome in which the balances associated with the payment scheme may be modified.

Furthermore, processing of the transaction may comprise a payment scheme selection process for selecting at least one payment scheme, a balance associated with the selected payment scheme being capable of being modified dependent upon execution of the transaction. The scheme selection process may comprise a balance management process in which at least one transaction rule determines which payment scheme the transaction applies to.

Thus, in accordance with a preferred embodiment of the invention, an electronic transaction system is provided, said system enabling and facilitating the use of multiple balances on an electronic device.

In one embodiment, the electronic device is an electronic payment card, such as for example a smart card, which in certain embodiments may have processing capabilities. It is also preferred, although not essential, that the electronic payment device is a ‘stored value’ device, capable of receiving, storing and accessing a plurality of values such as an account balance.

One embodiment of the invention also provides a plurality of balances (or ‘values’, or ‘purses’), each balance being capable of independent modification or change, and being maintained in accordance with a particular payment scheme. One or more of the balances may be stored on the electronic payment card. Alternatively, one, some or all of the balances may be stored externally on a device other than the payment card. Similarly, processing of the balances may be performed entirely or partially on the electronic payment card, or may be performed entirely or partially elsewhere by another device or devices.

Examples of payment schemes include, but are not limited to, ‘cash’, ‘loyalty’, ‘free school meals’, ‘positive activity awards’ and so on.

In a preferred embodiment, each scheme is associated with exactly one balance, there being a 1:1 relationship. In other words, it is preferred that each scheme is associated with a single balance, which in turn is associated with only that scheme. However, the skilled addressee will appreciate that this is not necessarily the case and that a given scheme may, in some embodiments, be associated with more than one balance. For example, a ‘cash’ scheme may have a ‘personal’ balance and a ‘company expenses’ balance. Alternatively, a single balance may be associated with more than one scheme. For example, two different schemes called ‘wife’ and ‘husband’ may share a single balance much like a joint bank account, but allow and facilitate monitoring of card usage. Thus, schemes and balances may be implemented according to a variety of models without departure from the scope of the present invention.

Successful completion of a transaction (e.g. a purchase) may cause the modification or update of one, some or all of the balances. In certain embodiments the balances are stored on the card. The choice of which scheme (and, therefore, which balance) a given transaction should be applied to may be determined or selected by the user. This option may for example be given to a user at point of transaction and may be prompted and/or selected by means of an electronic point of transaction input device. Alternatively, another party (such as a retailer or service provider) may pre-determine which scheme(s) the transaction is to be associated with based upon certain criteria e.g. certain products are always paid for from a particular balance or account. Such criteria may be a transaction rule that is applied by the system in processing the transaction request. Alternatively, another party (such as a retailer or service provider) may be restricted as to which scheme(s) they can affect based on product or service offering e.g. a newsagent may not be able to affect a “positive activity” scheme which may be restricted to use at leisure centres.

In use, in accordance with one regime of operation in accordance with the invention, a card holder (i.e. user presents the payment device (for example an electronic transaction card) at an electronic point of sale (EPOS) when (s)he wishes to access or purchase services or goods. For the sake of simplicity and clarity, the invention is described herein in relation to an exemplary use wherein the user wishes to purchase goods. However, the system is not limited in this regard and is suited for use with other applications and in different situations, such as when accessing services (e.g. using leisure facilities or transportation).

The user's selected goods are communicated to the EPOS, which is also in communication with the user's payment card. When a transaction is requested, such as the purchase of a coffee, the relevant scheme and associated balance is determined and/or selected before attempting to complete the transaction.

Typically, further controls or checks will be applied before the transaction is attempted. These may include checks such as calculating whether the value of the new balance will contravene an upper or lower balance limit. In some embodiments, the requested transaction will not be completed if one or more checks fail. Thus, failure of one pre-execution check will cause the failure of the entire transaction request, and the transaction will not be executed. In a typical embodiment, a transaction will not be partially completed; a transaction is either successful in its entirety or will fail entirely. Thus, if the user has requested the purchase of a coffee and a muffin, the transaction will fail if the user does not have sufficient funds to pay the total for both items, even if there are sufficient funds for the payment of one item.

Preferably, the user is notified of the failure to complete the transaction, possibly with some type of explanation or reason.

In certain embodiments, one, all or some of the balances may be subject to a degree of security or protective control to prevent unwanted or unauthorised access of the balances. Each balance may be subject to a different form or level of security such as, for example, different access keys.

In certain realisations of the invention, there may be provided an electronic transaction system further comprising an intelligent management capability (such as an intelligent balance manager) for making more sophisticated selection choices in relation to the which schemes (and thus which balances) are associated with (and therefore modified or updated) as a result of the successful completion of a transaction.

In a preferred embodiment, the intelligent balance manager comprises means for storing, retrieving and/or manipulating one or more transaction rules. The transaction rules may be stored on the card, EPOS or other component within the transaction system. While it is preferred that the rule set can be modified or updated, certain embodiments may, by contrast, comprise a ‘read only’ transaction rule set such that the rules cannot or may not be altered.

In a typical realisation, the rule set is devised by one or more retailers who wish to tailor the card holder's shopping experience or influence his/her purchasing behaviour in a particular way. For example, a coffee shop proprietor may wish to persuade or encourage a card holder to regularly purchase coffee, as this has a high profit margin. Thus, an example transaction rule may stipulate that for every coffee purchased (by deducting the cost from the ‘cash’ scheme's balance), a loyalty point is accrued (by incrementing the ‘loyalty’ scheme's balance) until a specified quantity of loyalty points is accumulated, at which point the user is rewarded in some way (perhaps a free coffee, or by making a donation to a charity via the incrementation of a ‘charity’ scheme's balance).

The transaction system further comprises means for applying the set of transaction rules to one or more inputted transactions (purchases) which the card user wishes to make. Typically, the rules are executed by the EPOS device, although the skilled addressee will appreciate that other system components may be responsible for executing the transaction rules.

In one realisation, application of the transaction rules to the intended purchases causes a one or more ‘update sets’ to be generated. (The purchases are only ‘intended’ transactions at this point as the transaction may fail, e.g. due to insufficient funds, as discussed above).

The term ‘update set’ is defined herein as a set of (one or more) operations which may be performed on balances associated with specified schemes. Thus, a user's request to make a purchase generates, after application of the transaction rules, a list of one or more update sets, each update set comprising, in turn, a set of balance operations. Each operation is an action which may be performed on the balance pertaining to a particular, selected scheme. In such a way the balances may be modified as a result of the transaction.

It should be noted that the operations associated with a particular update set may cause the update or modification of different balances. For example, a ‘buy coffee’ update set (generated as a result of requesting a ‘buy coffee’ transaction) may cause the ‘cash’ scheme balance to be debited by the cost of a coffee, and the ‘loyalty’ scheme balance to be credited with a predetermined number of points.

By way of illustration, consider the above scenario whereby a coffee shop proprietor wishes to encourage the sale of coffee by rewarding each coffee purchase with 1 loyalty point, such that the fifth coffee is provided to the card holder as free, reducing the loyalty scheme balance by 4 to ‘pay’ for the coffee. Now consider that the user wishes to purchase a coffee.

A transaction request is generated and inputted into the system (by scanning or swiping a bar code on the coffee, or manually entering the price of the coffee at a till, for example). For payment of the coffee, the user presents a stored value smart card configured in accordance with the present invention. The EPOS ‘knows’, due to the inputted purchase request, that the user wishes to purchase a coffee.

The transaction rule (or rules) associated with the ‘purchase coffee’ transaction are applied or executed by the EPOS causing, in turn, the generation of a ‘buy coffee’ update set, which is associated with the ‘buy coffee’ transaction. The ‘buy coffee’ update set consists of two scheme balance operations: 1) reduce the cash scheme balance by the cost of a coffee and 2) increment the loyalty scheme balance by the appropriate value. The rule may also generate a ‘redeem coffee points’ update set which could, for example, comprise one scheme balance operation 1) reduce the loyalty scheme balance by 4 (to effectively ‘pay’ for free coffee).

Thus, in this illustrative scenario, the (intended) purchase of a coffee has generated two update sets: the ‘buy coffee’ update set and the ‘redeem coffee points’ update set. If the user intends to purchase several items, at least one update set may be generated for each item on the user's inputted purchase list. An update set may be generated for each combination of redemption possibilities as well as an update set for the total value spent. For example, the purchase of a coffee and a muffin, totaling 350 would generate one update set wherein 350 is deducted from the ‘cash’ balance and the ‘loyalty’ balance incremented by 1, wherein the loyalty point is earned or accrued through the purchase of the coffee.

Upon generation of the update sets for the inputted purchases, the update sets are compared against the respective scheme balances stored on the card, to evaluate their validity (i.e. their ability to be executed). For example, if a user wishes to purchase a coffee but the current cash scheme balance is less than the price of a coffee, the ‘buy coffee’ update set will fail. Similarly, if the user has not accumulated sufficient loyalty points to earn a free coffee, the ‘redeem coffee points’ update set will fail and the operations associated therewith will not be performed on the relevant balances.

The criteria used during the testing of the update sets against the balances is, in a typical embodiment, predetermined by a party other than the card holder, such as a retailer or service provider or card issuer. Typical checks used during the comparison process include testing each update operation (e.g. debit or credit operation) to evaluate whether execution of the operation would cause the new balance to exceed or fall below a predetermined threshold level. Thus, in accordance with the invention, means for testing or comparing each update set against the current card balance(s) is provided such that their ability to execute may be assessed.

In a typical embodiment, the success of an update set for a given transaction prevents or cancels the assessment (and therefore potential execution) of any subsequent update sets associated with the same transaction. In the above example, if the ‘redeem coffee points’ update set is successfully tested for execution (i.e. the loyalty scheme balance can be validly debited) the ‘buy coffee’ update set need not be tested (or, therefore, executed).

Thus, the skilled addressee will understand that the order in which the update sets are tested and/or executed can be highly relevant to the performance of the transaction system. For example, in the above exemplary scenario, if the ‘buy coffee’ update set is always tested prior to the ‘redeem coffee points’ update set, then (assuming there are sufficient funds in the cash scheme to enable debiting of the price of the coffee) the card holder will not be able to avail himself of a free coffee even if he has accumulated sufficient loyalty points to merit it.

In certain embodiments, after assessing the validity of the update sets against the current balances, the card holder is offered the option of which update set to select for execution. For example, as a result of testing the ‘redeem coffee points’ update set and determining that sufficient points have been accrued to earn a free coffee, the user is asked whether a free coffee is desired or whether the card holder wishes to pay by cash and/or continue to accumulate further loyalty points rather than redeeming them. The card holder's response will then determine which update set is selected for execution.

An embodiment of the intelligent balance management described herein may, therefore, be summarised as follows:

```
for each ( update set )
{
    for each (balance operation in update set )
    {
        if (scheme NOT supported )
        {
            break from loop and try next update set
        }
        if ( balance operation and amount NOT within balance limits
)
        {
            break from loop and try next update set
        }
    }
    all operations in update sets can be satisfied
    apply to multiple balances on card
    break from loop
}
throw exception as unable to satisfy any update set
```

The features of the invention described above offer the advantage, therefore, of providing a transaction system which is more flexible than a single balance system, and provides the card holder with the freedom to choose how to conduct or pay for transactions.

In addition, the invention provides the advantage that the retailer, service provider or card issuer may market certain goods or services in a desired fashion, by offering the card holder different options (such as paying with a particular scheme) or accumulating rewards (such as buy four coffees, get the fifth free).

An embodiment of the invention will now be described, by way of example only, and with reference to the accompanying drawings, in which:

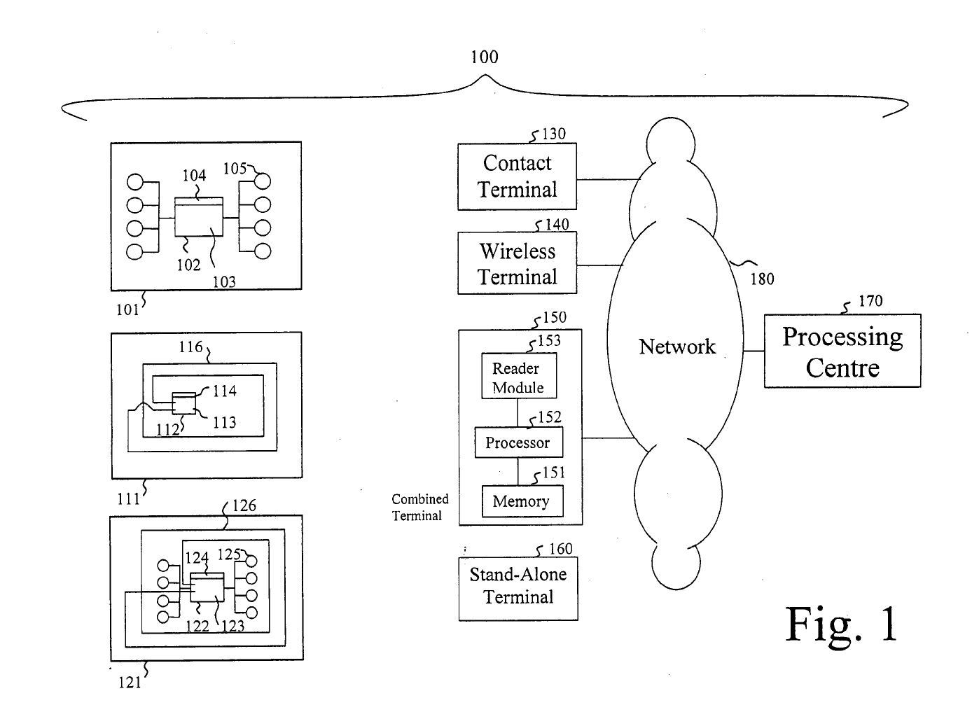

FIG. 1 shows an exemplary embodiment of the present invention and illustrating possible components of the system.

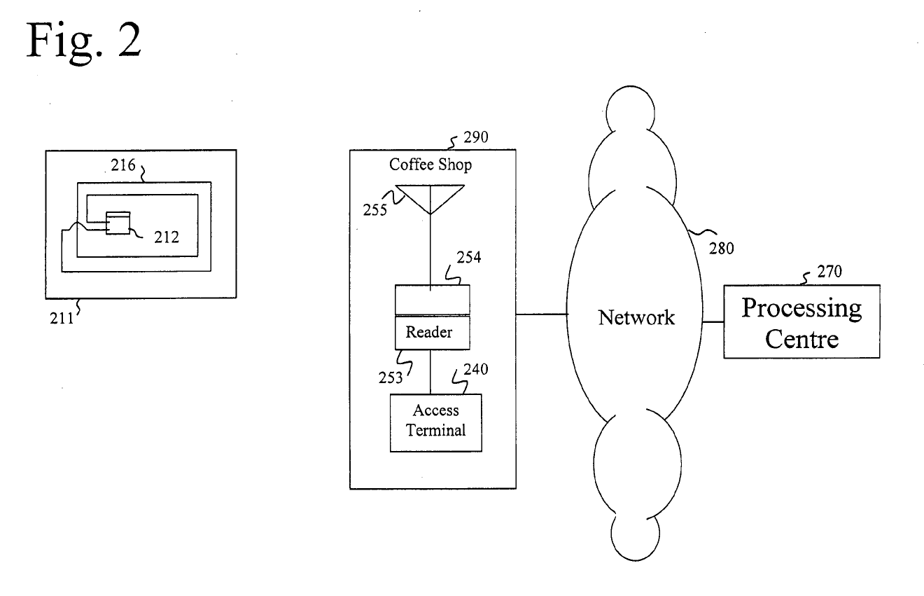

FIG. 2 shows an exemplary use of the invention in relation to a coffee shop application.

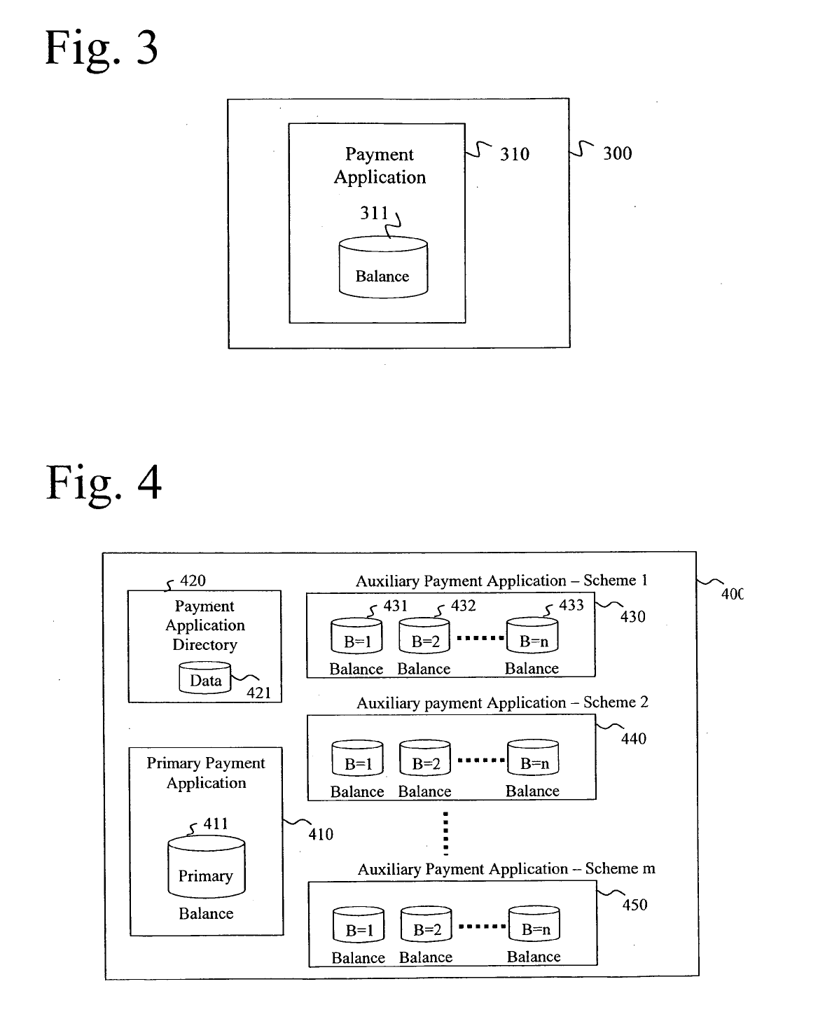

FIG. 3 shows a smart card chip having a stored value application with a single on-device balance

FIG. 4 shows an embodiment of the invention, having a plurality of balances stored on a transaction device.

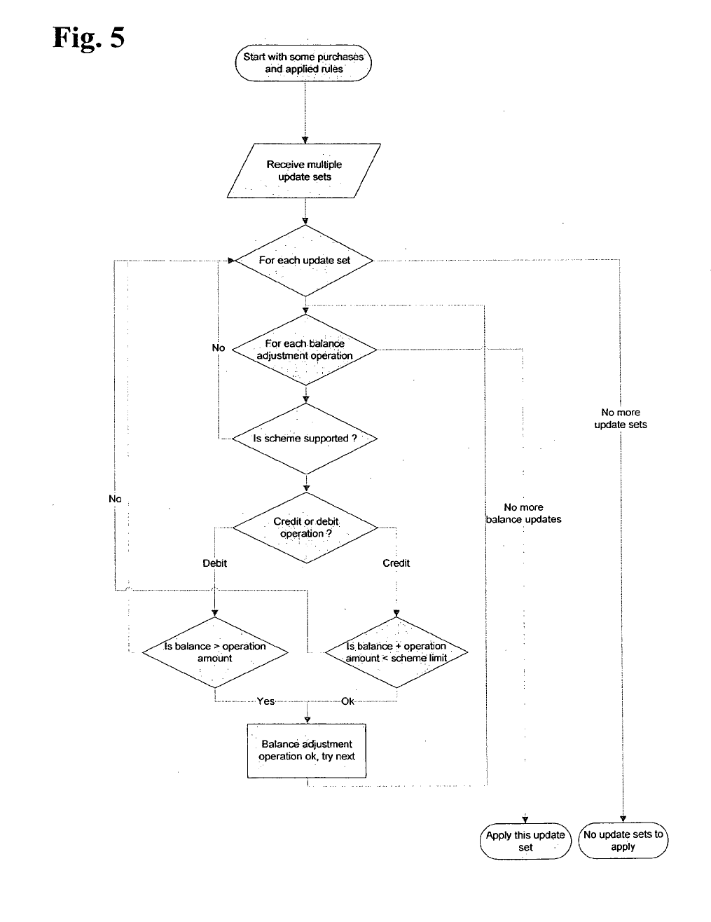

FIG. 5 illustrates the steps which may be taken when using a transaction system arranged and configured in accordance with an embodiment of the present invention.

Attention should now be given to FIG. 1, which shows an exemplary embodiment of a system 100, according to an aspect of the present invention, and including various possible components of the system. System 100 can include one or more different types of portable devices. For example, one such device can be a contact device such as a card 101. The card 101 can include an Integrated Circuit Chip (ICC). In addition to or instead of a card 101, system 100 can also be designed to work with a contactless device such as card 111. Card 111 can include an ICC 112 having a processor portion 113 and a memory portion 114. An antenna 116 can be provided for contactless communication, such as, for example, using Radio Frequency (RF) electromagnetic waves. Note that cards 101 and 111 are exemplary of a variety of devices that can be employed with techniques of the present invention. In a preferred embodiment of the invention, a dual interface device 121 is employed. Device 121 includes an ICC 122 having a processor portion 123 and a memory portion 124. A plurality of electrical contacts 125, similar to contacts 105, can be provided as well as an antenna 126 similar to antenna 116. Appropriate firmware to manage the two available interfaces can be provided, with operation otherwise being similar to devices 101, 111. The description of devices, elements, or components 111, 102, 103, 104, 105, 111, 112, 113, 114, 116, throughout this document are equally applicable to the corresponding items 121, 122, 123, 124, 125, 126.

The ICCs 102, 112 can contain processing units 103, 113 and memory units 104, 114. Preferably, the ICCs 102, 112 can also include one or more of control logic, a timer and input/output ports. Such elements are well known in the ICC art and are not separately illustrated. One or both of the ICCs 102, 112 can also include a co-processor, again, well known and not illustrated. The control logic can provide, in conjunction with processing units 103, 113, the control necessary to handle communications between memory unit 104, 114 and the input/output ports. The timer can provide a timing reference signal from processing units 103, 113 and the control logic. The co-processor could provide the ability to perform complex communications in real time, such as those required by cryptographic algorithms.

The memory portions of units 102, 112 may include different types of memory, such as volatile and non-volatile memory and read-only and programmable memory. The memory units can store transaction card data such as, e.g., a user's Identification number. The memory portions of 102, 112 can store the operating system of the cards 101, 111. The operating system loads and executes applications and provides file management or other basic card services to the applications. In some embodiments, one or more applications may reside directly on hardware, e.g., may be outside the domain of the operating system. The operating system used to implement the present invention may be openly available such as those based on Java Card™ technology (licensed by Sun Microsystems Inc., 4150 network Circle, Santa Clara, Calif. 95054, USA), proprietary operating systems available from a number of vendors, could also be deployed. Preferably, the operating system is stored in read-only memory (“ROM”) within memory portions 104, 114. In an alternate embodiment, flash memory or other non-volatile and/or volatile types of memory may also be used in the memory units 104, 114.

In addition to the basic services provided by the operating system, memory portions 104, 114 may also included one or more applications as described herein. At present, one preferred standard to which such applications may conform is the ITSO electronic ticketing standard set by the ITSO organisation (http://www.itso.org.uk). It will be appreciated that, strictly speaking, the ITSO standard defines an end-to-end ticketing system; however the card can be configured to conform to such an ITSO-compliant system and in such a sense is itself ITSO-compliant. It will be appreciated that applications in accordance with the present invention can be configured in a variety of different ways.

As noted cards 101, 111 are examples of a variety of payment devices that can be employed with techniques of the present invention. The primary function of the payment device may not be payment, for example, they may be cellular telephone handsets, or payment cards for debit/credit applications, that implement techniques of the present invention. Such devices could include cards having a conventional form factor, smaller or larger cards, cards of different shape, key fobs, personal digital assistants (PDAs), appropriately configured cellular telephone handsets, or indeed any device with the processing and memory capabilities to implement techniques of the present invention. The cards, or other payment devices, can include body portions (e.g., laminated plastic layers of a payment card, case or cabinet of a PDA, chip packaging, and the like), memories 104, 114 associated with the body portions, and processors 103, 113 associated with the body portions and coupled to the memories. The memories 104, 114 can contain applications as described herein. The processors 103, 113 can be operative to execute one or more method steps to be described herein. The application can be, for example, application identifiers (AIDs) linked to software code in the form of firmware plus data in a card memory such as an electrically erasable programmable read-only memory (EEPROM).

A number of different types of terminals can be employed with system 100. Such terminals can include a contact terminal 130 configured to interface with contact type device 101, a wireless terminal 140 configured to interface with wireless device 111, or a combined terminal 150 designed to interface with either type of device 101, 111. Most typically, terminals are contact terminals with plug-in contactless readers. Combined terminal 150 can include a memory 151, a processor 152, and a reader module 153. Note that the principles of construction of terminal 150 are applicable to other types of terminals and are described in detail for illustrative purpose. Reader module 153 can be configured for contact communication with card or device 101, or contactless communication with card or device 111, or both (different types of readers can be provided to interact with different types of cards e.g., contact or contactless). Terminals 130, 140 150 can be connected to a processing centre 170 via a network 180. Network 180 could include, for example, the Internet, or a proprietary network. Processing centre 170 can include, for example, a host computer of an issuer of a payment device.

Stand-alone terminal 160 is representative of a terminal that is not connected to a network (either not connected at a particular moment in time or not connected at all by design), and is generally similar to the other terminals described.

In one aspect of the current invention, a portable payment device is provided for facilitating transactions by a user with a terminal such as 130, 140, 150, 160, of a system such as system 100. The device can include a processor, for example, the processing units 102, 112, 122 discussed above. The device can also include a memory, such as memory portions 104, 114, 124 discussed above, that is coupled to the processor. Further the device can include a communication module that is coupled to the processor and configured to interface with a terminal such as one of the terminals 130, 140, 150, 160. The communications module can include, for example, the contacts 105 or the antennas 116, 126, together with appropriate circuitry that permits interfacing with the terminals via contact or contactless communication. The processor of the apparatus can be operable to perform one or more steps of methods and techniques described herein. The processor can perform such operations via hardware techniques, and/or under the influence of program instructions stored in one of the memory units; in one exemplary preferred embodiment, via the instructions in one or more payment applications described herein.

The portable device can include a body portion. For example, this could be a laminated plastic body (as described above) in the case of “smart” cards 101, 111, or the handset chassis and body in the case of a PDA or Cellular telephone. The device can be limited to the stored value application(s), but can also include a payment application without an on-device balance, such as a server-based wallet. One approach to providing such an arrangement would be to have additional applications running on processor portions 103, 113 and stored in memory portions 104, 114. For example these could include a conventional access control application in addition to the payment application with on-device balances. Conventional magnetic stripes could be included on cards 101, 111 for conventional purposes, and for the convenience of having such stripes co-located with the other features described herein.

It will be appreciated that the terminals 130, 140, 150, 160 are examples of apparatus for interacting with portable payment devices in accordance with one or more exemplary embodiments of the present invention. The apparatus can include a memory such as memory 151 that is coupled to a processor such as processor 152, and a reader module such as 153 that is coupled to the processor 152 and configured to interface with the portable devices 101, 111. The processor 152 can be operable to communicate with portable payment devices of the user via the reader module 153. The terminal apparatus can function via hardware techniques in processor 152, or by program instructions stored in memory 151. Such logic could optionally be provided from a central location such as processing centre 170 over the network 180.

Attention should now be given to FIG. 2, which depicts a system 200 employing certain techniques of the present invention applied to an exemplary coffee shop 290. It is understood that this is illustrative of one of many possible applications of techniques of the present invention. Customer purchase of items in coffee shop 290 is paid for by portable payment devices 211 and terminal 240. Elements in FIG. 2 similar to those in FIG. 1 have received the same reference character incremented by 100 and will not be described in detail again. Thus, devices 211, ICCs 212, antennas 216, terminals 240 and reader modules 253 are similar to those discussed above with respect to FIG. 1. The reader modules can contain communications circuitry 254 and antennas 255 for wireless communication with antennas 216. Contact solutions could also be employed, in addition to or in lieu of contactless solutions.

When a customer wishes to buy a coffee and muffin, (s)he causes device 211 to communicate with access terminal 240 (for example by touching or tapping at a designated location, or holding in close proximity to such location), which may reduce a balance of a payment application on device 211.

FIG. 3 shows a smart card chip 300 having a stored value application 310 with an on-device balance 311 that is reduced by the total value of customer purchases. By restricting to a single on-device balance 311 dedicated to the transaction, the total value of the transaction is reduced from the balance. Greater flexibility is achieved if multiple on-device balances can be intelligently manipulated.

FIG. 4 shows one preferred implementation of techniques of the present invention. A smart card chip 400 with a primary payment application 410 with an on-device primary balance 411. There also exists a payment application directory 420 which knows about the existence of other co-located auxiliary payment applications 430, 440, 450 through a register held in its database 421. Payment application 430, comprises a series of sub-balances 431, 432, 433, each dedicated to an identifiable product grouping. The number of auxiliary payment applications on the chip 400, is limited only by the application issuer and/or amount of space available on the device. Similarly, the number of sub-balances available per auxiliary payment application on the chip 400, is limited only by the application issuer and/or amount of space available on the device.

It is to be understood that desirably, the user of a card or other payment device is simply aware of a single balance for every instance of the auxiliary payment application despite the fact that two or more sub-balances may be available in any auxiliary payment application present on the device. This should preferably be accomplished in a way that aggregates multiple sub-balances in an auxiliary payment application into a single balance per auxiliary payment application. In one exemplary form of the present invention, aggregation is handled on the card or other portable payment device without requiring any change to transaction flow or new terminals. However, it should be understood that one or more method steps depicted herein could be carried out under terminal control, or a combination of on-device and terminal control could be used.

Attention should now be given to FIG. 5, which shows a flow chart 500 of exemplary method steps in a method, which can be computer implemented, of intelligently managing multiple payment application balances. It is to be emphasised that sequences and steps other than those shown in FIG. 5 are also within the scope of the present invention. After beginning at block 501, the method receives a payment request 502 that comprises amounts broken down into individual requested amounts within a specified scheme. It is to be noted that more than one scheme may form part of the received request. Step 503 seeks to verify that the scheme is one that the payment application supports. The method can optionally include a step that verifies whether the user has authorised the use of balances of a particular scheme or has restricted use to the primary payment application balance only.

As shown in step 504, the payment application must verify for each and every requested amount whether there is sufficient value in the corresponding balance to cover the requested amount. A successful outcome of step 504 leads to step 505, thus if the sub-balance is greater than the corresponding requested amount, the requested amount is deducted from the sub-balance. An un-successful outcome of step 504 reduces the value of the amount requested by the residual balance in the corresponding sub-balance and sets the said sub-balance to zero.

In one or more forms of the invention, the allocation of requested amounts to their corresponding on-device balances as shown in method 506 is repeated for every requested amount. Once method 506 is completed, the result is a series of amounts that may have not been met from corresponding sub-balances, and therefore, must be met from the balance of the primary payment application. It is to be noted that these individual amounts may be unchanged from the original requested amount, reduced from the original requested amount by virtue of being partially off-set by corresponding value in a sub-balance, or zero in cases where the originally requested amount was fully met by the corresponding sub-balance. Step 507 accumulates all the amounts produced by method 506 into a single outstanding total amount. Step 508 verifies whether there are sufficient funds in the primary application balance to satisfy the total amount outstanding as a result of step 507. If the primary application balance has sufficient funds, the primary application balance is modified (i.e. reduced by the outstanding total amount in step 509) and the payment succeeds as shown in step 510. If the primary application balance is insufficient to meet the outstanding amount, the payment request fails as shown in step 511. In all cases the method completes in step 512.

Application selection is the process by which, for example, the terminal and/or reader (under control, e.g., of terminal or reader software or logic), issues a command to the payment device, which has the effect of activating a particular software application on the device. Such selection can be explicit, where the device activates an application specified by the terminal, or implicit, where the terminal need not specify a particular application for the particular application to be activated. In one or more embodiments of the invention, the intelligent use of multiple balances can be conducted in response to the explicit transaction request containing a multiple of requested amounts.

It will also be appreciated that a terminal apparatus for interacting with a portable payment device of the kind described herein can include a reader module; a memory associated with the reader module; and at least one processor coupled to the memory. The processor can be operative to perform one or more of the method steps described herein, for example, explicit selection of the payment application. While it is believed preferable that techniques of the present invention are implemented entirely or primarily on a card or other payment device, it should be understood that method steps and actions described herein can be performed by a payment device, a terminal, or a combination of the foregoing.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An electronic transaction system, the system comprising:
an electronic transaction device;
a plurality of balances, each being linked to the transaction device and electronically stored in association with a transaction scheme; and
transaction processing means for processing a transaction request associated with the electronic transaction device, the transaction processing means comprising means for inputting the transaction request and processing the transaction request to provide an outcome in which the balances associated with the transaction scheme may be modified.

2. An electronic transaction system according to claim 1 and further comprising means for generating at least one update set in response to said transaction request, each update set comprising at least one operation which may be performed on a balance associated with a transaction scheme.

3. An electronic transaction system according to claim 2 wherein the at least one update set is generated by applying at least one transaction rule to the transaction request, the transaction rule being associated with the transaction request.

4. An electronic transaction system according to claim 3, comprising means for storing, retrieving or manipulating the at least one transaction rule associated with the transaction request.

5. An electronic transaction system according to claim 2, comprising means for testing or comparing each update set against a respective balance so as to assess the ability of the update set to execute.

6. An electronic transaction system according to claim 1 and comprising a transaction scheme selection means for selecting at least one transaction scheme, wherein a balance associated with the selected payment scheme is capable of being modified dependent upon execution of the transaction.

7. An electronic transaction system according to claim 6 wherein the transaction scheme selection means receives input requested from a user concerning their preferred transaction scheme.

8. An electronic transaction system according to claim 1 wherein the transaction processing means is arranged to review information relating to the plurality of balances prior to modification of the balances.

9. An electronic transaction system according to claim 1 wherein the transaction fails to complete if modification of at least one balance would contravene an upper or lower balance limit.

10. An electronic transaction system according to claim 9 wherein the user is notified of the failure to complete the transaction.

11. An electronic transaction system according to claim 1 further comprising means for verifying the identity of the user of the electronic transaction device.

12. An electronic transaction system according to claim 1 wherein the transaction processing means is an electronic point of sale device.

13. An electronic transaction system according to claim 1 wherein the transaction processing means is a processor remote from an electronic point of sale device which receives the transaction request and/or the plurality of balances is stored on the electronic transaction device.

14. An electronic transaction system according to claim 1 wherein the electronic transaction device is a transaction payment card.

15. An electronic transaction processing method, said method comprising:
electronically storing a plurality of balances, each balance being associated with a transaction scheme, the balances being linked to an electronic transaction device; and
processing a transaction request associated with the transaction device, the transaction processing comprising the steps of:
receiving the request to execute the transaction; and
processing the transaction to provide an outcome in which a balance associated with a transaction scheme may be modified.

16. An electronic transaction processing method according to claim 15, further comprising the step of generating at least one update set in response to said transaction request, each update set comprising at least one operation which may be performed on a balance associated with a transaction scheme.

17. An electronic transaction processing method according to claim 16, and further comprising the step of applying at least one transaction rule to the transaction request to generate the at least one update set.

18. A method according to claim 15 wherein the transaction processing step further comprises selecting at least one transaction scheme, a balance associated with the selected transaction scheme being capable of being modified dependent upon execution of the transaction.

19. An electronic transaction processing method according to claim 16, further comprising the step of comparing the at least one update set against a respective scheme balance to evaluate the validity of the update set prior to execution of the transaction.

20. A method according to claim 15, wherein the transaction request processing comprises reviewing information relating to the plurality of balances prior to modification of the balances.

21. A method according to any of claim 15 wherein the plurality of balances is stored on an electronic transaction device and/or the electronic transaction device is a transaction payment card.
